(19) United States
(12) Patent Application Publication
(10) Pub. No.: US 2020/0206676 A1
(43) Pub. Date: Jul. 2, 2020

(54) ERODANTS AS CONVEYANCE AIDS AND METHOD OF MERCURY REMOVAL

(71) Applicant: Cabot Corporation, Boston, MA (US)

(72) Inventors: Gerald D. Adler, Charlestown, MA (US); Kenneth C. Koehlert, Hollis, NH (US); Matthew B. Greenfield, Medway, MA (US); Geoffrey D. Moeser, Groton, MA (US)

(21) Appl. No.: 16/631,297

(22) PCT Filed: Jul. 3, 2018
(86) PCT No.: PCT/US2018/040702

§ 371 Date: Jan. 15, 2020

Related U.S. Application Data
(60) Provisional application No. 62/533,310, filed on Jul. 17, 2017.

(51) Int. Cl. B01D 53/12; B01J 20/20; B01J 20/28

(52) U.S. Cl. CPC B01D 53/12; B01J 20/20; B01D 2257/602; B01D 2253/102; B01D 2253/304; B01J 20/28004

(57) ABSTRACT

Aspects of the present disclosure are directed to mixtures and methods for pneumatically conveying powdered materials. A method includes providing a pneumatic conveyance system with a gas stream having a gas velocity; providing particles of sorbent material having a median sorbent particle size d_{50, sorbent} from 1 μm to 28 μm; injecting the particles of sorbent material into the gas stream; providing particles of erodant material having a median erodant particle size d_{50, erodant} of at least 150 μm, where the erodant material is provided in an amount from 0.5% to 3% by weight of the particles of sorbent material; and injecting the particles of erodant material into the gas stream, where the gas velocity is sufficient to entrain the particles of sorbent material and sufficient to convey the particles of erodant material. A mixture of sorbent material and erodant material is also disclosed.

### CROSS REFERENCE TO RELATED APPLICATION

This application claims priority to U.S. Provisional Patent Application No. 62/533,310, filed on Jul. 17, 2017, hereby incorporated by reference.

### FIELD OF THE DISCLOSURE

This disclosure relates to pneumatic conveyance of particles, and more particularly, to a method of pneumatic conveyance using erodant particles.

### BACKGROUND

Due to air quality and emissions regulations, utility plants that burn coal must often treat any flue gas to ensure it contains only certain levels of regulated compounds, such as nitrogen oxides (NOₓ), sulfur oxides (SOₓ), and heavy metals, such as mercury. Typically, sorbents are injected into the flue gas to adsorb mercury impurities prior to discharging the gas into the environment. In a power plant, for example, particulate sorbents are injected into the flue gas stream downstream of a coal-fired boiler where the sorbent material adsorbs mercury and other impurities.

### SUMMARY

Aspects of the present disclosure are directed to methods of pneumatically conveying fine-particle materials, methods of removing contaminants from flue gas streams, and mixtures of sorbent and erodant materials useful for improved conveyance in pneumatic conveyance systems.

One aspect of the present disclosure is directed to a method of pneumatically conveying fine particles, such as in a pneumatic conveyance system with a gas stream having a gas velocity sufficient to entrain particles of sorbent material and sufficient to convey particles of erodant material. In one embodiment, the method includes the steps of injecting particles of sorbent material into the gas stream, where the particles of sorbent material have a median sorbent particle size d₅₀, sorbent from 1 μm to 28 μm; and injecting particles of erodant material into the gas stream in an amount from 0.5% to 3% by weight of the particles of sorbent material, where the particles of erodant material have a median erodant particle size d_{50, erodant} of at least 150 μm.

In another embodiment, the method includes the steps of injecting particles of sorbent material and particles of erodant material into a gas stream of a pneumatic conveyance system, where the gas velocity is sufficient to entrain the particles of sorbent material and sufficient to convey the particles of erodant material. In one embodiment, the method includes injecting particles of sorbent material have a median sorbent particle size d_{50, sorbent} and a 95^{th} percentile size d₉₅, where a ratio of d₉₅ to d₅₀ is from 1.5 to 3. The method also includes injecting particles of erodant material into the gas stream, where the particles of erodant material have a particle size distribution d_{95, erodant}, where at least 95% of the particles of erodant material have a mass at least 100 times a mass of the particles of sorbent material of median sorbent particle size d₅₀, sorbent.

In some embodiments, the step of injecting the particles of sorbent material and the step of injecting the particles of erodant material is performed by injecting a heterogeneous mixture comprising the particles of sorbent material and the particles of erodant material.

In some embodiments, the step of injecting the particles of erodant material into the gas stream is performed continuously.

In some embodiments, the step of injecting the particles of erodant material into the gas stream is performed periodically.

In some embodiments, the step of injecting the particles of erodant material into the gas stream is performed intermittently.

In some embodiments, the method also includes the step of detecting an accumulation of the particles of sorbent material on a surface of the pneumatic conveyance system. In one embodiment, the step of detecting the accumulation of the particles of sorbent material is performed at least in part by detecting a change in a system pressure drop of the pneumatic conveyance system. In another embodiment, the step of detecting the accumulation of the particles of sorbent material is performed at least in part by detecting a change in a receiving rate of the particles of sorbent material.

In some embodiments, at least 95% of the particles of the erodant material have a mass at least 100 times a mass of one particle of the sorbent material of the median sorbent particle size d_{50, sorbent}. In another embodiment, at least 95% of the particles of the erodant material have a mass at least 1000 times a mass of one particle of the sorbent material of the median sorbent particle size d_{50, sorbent}. In another embodiment, at least 95% of the particles of the erodant material have a mass at least 10,000 times a mass of a particle of the sorbent material of the median sorbent particle size d_{50, sorbent}. In another embodiment, at least 95% of the particles of the erodant material have a mass at least 50,000 times a mass of a particle of the sorbent material of the median sorbent particle size d₅₀, sorbent. In another embodiment, at least 95% of the particles of the erodant material have a mass at least 100,000 times a mass of a particle of the sorbent material of the median sorbent particle size d_{50, sorbent}. In another embodiment, at least 95% of the particles of the erodant material have a mass at least 1,000,000 times a mass of a particle of the sorbent material of the median sorbent particle size d₅₀, sorbent.

In some embodiments, the particles of erodant material are injected in an amount from 0.5% to 2% or 0.5% to 3.0% by weight of the particles of sorbent material.

In some embodiments, the gas stream is selected to contain flue gas generated from coal combustion. In some embodiments, the particles of sorbent material are selected to comprise activated carbon having the median sorbent particle size d₅₀, sorbent ranging from 1 μm to 28 μm. In other embodiments, the median sorbent particle size d₅₀, sorbent ranges from 8 μm to 12 μm.

In some embodiments, the particles of erodant material are selected to comprise granular activated carbon with a particle size of at least 50 mesh. For example, the granular activated carbon has a particle size distribution of 8×20 mesh.

In some embodiments, the particles of erodant material are selected to comprise granular activated carbon with a particle size distribution of 20×80 mesh.

In some embodiments, the particles of erodant material are selected to comprise crystalline silica with a particle size of at least 100 mesh. In other embodiments, the particle size is at least 80 mesh. In yet other embodiments, the particle size is at least 70 mesh.

In some embodiments, the step of injecting the particles of erodant material is performed in a quantity from 0.5% to 2.0% or 0.5% to 3.0% by weight of the particles of sorbent material.

In some embodiments, the particles of erodant material are selected to comprise one or more materials selected from granular activated carbon, silica, quartz sand, sea shell, walnut shell, pecan shell, corn hull, olive pit, peach pit, rubber, rice hull, coconut hull, corncob, coal, wood chips, metal filings, beach sand, aluminum oxide, glass beads, plastic beads, plastic particles, coal slag, mineral slag, petroleum coke, steel grit, steel shot, staurolite mineral, pumice, garnet, granite, silicon carbide, silicon, and sodium bicarbonate. In some embodiments, at least some of the particles of erodant material are selected to have a spheroidal shape. In some embodiments, the median particle size d₅₀, sorbent is selected from 8 μm to 18 μm and the particles of erodant material are selected to have a particle size greater than 100 mesh. In another embodiment, the particles of erodant material have a particle size greater than 50 mesh.

A second aspect of the present disclosure is directed to a method of removing mercury from flue gas resulting from coal combustion. For example, the flue gas has a gas velocity sufficient to entrain the particles of sorbent material in the flue gas stream and sufficient to convey the particles of erodant material through a conduit. In one embodiment, the method includes injecting particles of sorbent material into a flue gas stream from coal combustion, where the particles of sorbent material have a median sorbent particle size d₅₀, sorbent from 1 μm to 28 μm. The method also includes injecting particles of erodant material into the flue gas stream in an amount from 0.5% to 3% by weight of the particles of sorbent material, where the particles of erodant material have a median erodant particle size d_{50, erodant} of at least 150 μm.

In another embodiment, the method includes the steps of injecting particles of sorbent material into a flue gas stream from coal combustion, where the flue gas stream flows through a conduit and where the particles of sorbent material have a median sorbent particle size d_{50,sorbent} ranging from 1 μm to 28 μm. The method also includes injecting the particles of sorbent material into the flue gas stream, where at least 95% of the particles of erodant material have a mass at least 100 times a mass of one of the particles of sorbent material of the median sorbent particle size d₅₀, sorbent.

In some embodiments, the particles of sorbent material are selected as powdered activated carbon.

In some embodiments, the particles of sorbent material are selected to have a particle size distribution with a ratio of d₉₅ to d_{50, sorbent} ranging from 1.5 to 3. In some embodiments, the particles of sorbent material are selected to have the median sorbent particle size d₅₀, sorbent ranging from 8 μm to 18 μm or from 8 μm to 12 μm.

In some embodiments, the particles of erodant material are selected to comprise granular activated carbon with an erodant particle size greater than 50 mesh. For example, the granular activated carbon has a particle size distribution of 8×20 mesh.

In some embodiments, the particles of erodant material are selected to comprise granular activated carbon having a particle size distribution of 20×80 mesh.

In some embodiments, the particles of erodant material are selected to comprise crystalline silica with an erodant particle size greater than 100 mesh. In other embodiments, the erodant particle size is selected to be greater than 80 mesh. In other embodiments, the erodant particle size is selected to be greater than 70 mesh.

In some embodiments, the particles of erodant material are selected to comprise one or more materials selected from granular activated carbon, silica, quartz sand, sea shell, walnut shell, pecan shell, corn hull, olive pit, peach pit, rubber, rice hull, coconut hull, corncob, coal, wood chips, metal filings, beach sand, aluminum oxide, glass beads, plastic beads, plastic particles, coal slag, mineral slag, petroleum coke, sodium bicarbonate, steel grit, steel shot, staurolite mineral, pumice, garnet, granite, silicon carbide, and silicon.

A third aspect of the present invention is directed to a mixture of powdered activated carbon and erodant particles. In one embodiment, the mixture includes powdered activated carbon with a median sorbent particle size d_{50, sorbent} from 1 μm to 28 μm. The mixture also includes granules of erodant material having a median erodant particle size d_{50, erodant} of at least 150 μm, where the granules of erodant material are present in an amount from 0.5% to 3% by weight of the particles of the powdered activated carbon.

In another embodiment, the mixture includes powdered activated carbon in a first quantity of at least 97% by weight of the mixture. The powdered activated carbon has a median sorbent particle size d₅₀ from 1 μm to 28 μm. The mixture also includes granules of erodant material in a second quantity of least 1% by weight of the mixture, where at least 95% of the granules of erodant material have a mass at least 100 times a sorbent particle mass of one particle of powdered activated carbon with a particle size equal to the median sorbent particle size d_{50, sorbent}. The powdered activated carbon is heterogeneously mixed with the granules of erodant material.

In some embodiments, the granules of erodant material are one or more materials selected from granular activated carbon, silica, quartz sand, sea shell, walnut shell, pecan shell, corn hull, olive pit, peach pit, rubber, rice hull, coconut hull, corncob, coal, wood chips, metal filings, beach sand, aluminum oxide, glass beads, plastic beads, plastic particles, coal slag, mineral slag, petroleum coke, steel grit, steel shot, staurolite mineral, pumice, garnet, granite, silicon carbide, silicon, or sodium bicarbonate.

In another embodiment, at least 95% of the granules of erodant material have a mass at least 100 times the sorbent particle mass of one particle of powdered activated carbon with a particle size equal to the median sorbent particle size d_{50, sorbent}. In another embodiment, at least 95% of the granules of erodant material have a mass at least 1000 times the sorbent particle mass of one particle of powdered activated carbon with a particle size equal to the median sorbent particle size d_{50, sorbent}. In another embodiment, at least 95% of the granules of erodant material have a mass at least 10,000 times the sorbent particle mass of one particle of powdered activated carbon with a particle size equal to the median sorbent particle size d_{50, sorbent}. In another embodiment, at least 95% of the granules of erodant material have a mass at least 100,000 times the sorbent particle mass of one particle of powdered activated carbon with a particle size equal to the median sorbent particle size d_{50, sorbent}. In another embodiment, at least 95% of the granules of erodant material have a mass at least 1,000,000 times the sorbent particle mass of one particle of powdered activated carbon with a particle size equal to the median sorbent particle size d_{50, sorbent}.

In another embodiment, the granules of erodant material have an erodant particle size distribution of 8×20 mesh. In another embodiment, the erodant particles have an erodant particle size distribution of 20×80 mesh.

In another embodiment, the granules of erodant material comprise granular activated carbon having an erodant particle size greater than 50 mesh. In another embodiment, the granules of erodant material comprise quartz sand having an erodant particle size greater than 100 mesh. In another embodiment, the quartz sand has an erodant particle size no greater than 60 mesh.

In some embodiments of the mixture, at least some of the granules of erodant material have a spheroidal shape.

In another embodiment, the median sorbent particle size from 8 μm to 18 μm. In another embodiment, the median sorbent particle size from 8 μm to 12 μm.

In another embodiment, the powdered activated carbon has a particle size distribution with a ratio of d₉₅ to d_{50, sorbent} ranging from 1.5 to 3.

In another embodiment, the mixture consists essentially of the powdered activated carbon and the granules of erodant material.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes and not to limit the scope of the disclosed subject matter.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended to limit the scope of the disclosure. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure.

FIG. 1 is a schematic diagram of a conveyance system as part of a power plant in accordance with an embodiment of the present disclosure.

FIG. 2 is a schematic diagram of a conveyance system as part of a power plant in accordance with another embodiment of the present disclosure.

FIG. 3 is a representative plot showing a particle size distribution of particles in a mixture containing sorbent material and erodant material.

FIG. 4 is a plot of experimental data showing system pressure drop, material feed rate, and material receiving rate vs. time for conveyance of sorbent material at a first gas flow rate and solids loading.

FIG. 5 is a plot of experimental data showing system pressure drop, material feed rate, and material receiving rate vs. time for conveyance of sorbent material at a second gas flow rate and solids loading.

FIG. 6 is a plot of experimental data showing system pressure drop, material feed rate, and material receiving rate vs. time for conveyance of sorbent material at the first gas flow rate and solids loading and with the addition of an erodant material.

FIG. 7 is a plot of experimental data showing system pressure drop, material feed rate, and material receiving rate vs. time for conveyance of sorbent material at the second gas flow rate and solids loading and with the addition of an erodant material.

### DETAILED DESCRIPTION

It is generally understood that particulate materials may be moved from one location to another location by pneumatic conveyance, where the particulate material is injected into a gas stream with a gas velocity sufficient to transport the material.

Pneumatic conveyance systems are often powered by a blower. Sorbent material may be added to the motive air either through an eductor or through a rotary air lock. While both systems are subject to limitations on the amount of material and distance the system can convey a material, systems with a rotary air lock are typically much more robust—as a closed system, temporary pressure events do not cause the system to overpressure at the inlet and trip. In contrast, the open eductor system cannot operate if the inlet port has a positive pressure.

In general, eductor-type systems are appropriate only when the solids loading in the gas flow is below 4%. Above this threshold, the system will struggle to move the solids an appreciable distance. Power plant systems often operate pneumatic conveyance systems with solids loadings less than 1% by weight. Other systems, including those with a rotary air lock, may be able to handle higher solids loadings. For example, some pneumatic conveyance systems have solids loadings greater than 4% by weight when transferring particulate solids from one location to another location.

In one useful application of pneumatic conveyance, particles of sorbent material are conveyed through a conduit to an injection point where the particles are injected into a flue gas stream to remove contaminants from the flue gas by adsorption. After particles of the sorbent material are injected into the gas stream, they become entrained in the flue gas and the sorbent material adsorbs contaminants, such as mercury. The sorbent material is then recovered from the gas stream using a particle collector before the flue gas exits to the environment through a stack.

Sorbent materials, such as activated carbon, are useful to remove contaminants from flue gases of coal-fired power plants. Activated carbon is an example of a sorbent material that is injected into the flue gas of a coal-fired boiler to adsorb mercury contaminants from the flue gas. Mercury binds to the surface of the particles in the available time (e.g., a several seconds) before the sorbent is removed from the flue gas stream.

Particles, including coarse material and powders, are commonly classified according to a particle size distribution of the material. Some reference values of the particle size distribution include a 95^{th} percentile by size, d₉₅. The 95^{th} percentile is a size that is greater than 95% of particles. The median particle size, d₅₀, is the size at which half of particles are smaller and half of particles are larger. The 5^{th} percentile, d₀₅, is a size that is greater than 5% of particles. One method of measuring particle size and determining the particle size distribution is the US Sieve Series, ASTM Specification E-11-61. The US Sieve Series is a series of sieves with wire mesh defining openings of a known size. Sorting bulk materials through the sieve series establishes the range of particle sizes and the particle size distribution across that range. Some refer to particles as falling between two sieves, where generally 85% of all particles pass through the first identified sieve and generally 95% of all particles are retained on the second identified sieve. For example, a material having particles with a size commonly referred to as 20×80 mesh will pass through an approximately #20 mesh sieve (generally 85% passing) and be retained on an approximately #80 mesh sieve (generally 95% retained). Another method for determining the particle size distribution of powdered activated carbon, including values for d₉₅ and d₅₀, is detailed in Norit Standard Test Method (NSTM) 24.04. Laser light with a wavelength of 750 nm is passed through particles suspended in a fluid. Diffracted light is collected on a Fourrier lens and focused on various detectors to measure the light intensity. The angle and intensity of areas in the composite diffraction pattern are used to calculate the particle size distribution. Another acceptable method for determining particle size distribution is detailed in ASTM D4464, Standard Test Method for Particle Size Distribution of Catalytic Materials by Laser Light Scattering.

Reducing the size of the sorbent material as measured by d₉₅ at a constant median particle size d₅₀ increases the specific external surface area of the sorbent material to the maximum extent possible at a given median particle size d₅₀. For contaminant removal by adsorption, it is believed that a material with a smaller median particle size d₅₀ will outperform materials with a larger median particle size d₅₀ because of the increased surface area per mass. It has been found that reducing d₉₅ for a given median particle size d₅₀ further improves contaminant removal from flue gas by adsorption due to increasing the surface area of the adsorbent material. This approach has been useful for removing mercury from the flue gas of coal-fired power plants.

It has been found that a frequently occurring problem with pneumatically conveying powdered sorbent materials is that the material is prone to buildup on pneumatic conveying line surfaces. As the particle size is reduced, the particles become more cohesive and stick to the walls of the conveying system. With activated carbon, for example, as particle size d₅₀ is reduced for improved performance in removing mercury contaminants, the cohesiveness of the material increases and the conveyability deteriorates. Moisture is also detrimental to conveyability, where an increase in moisture increases the cohesive strength of the material, making it more prone to cake and accumulate on surfaces of the conveying line. Some sorbent materials may be more hygroscopic than others. For example, brominated activated carbon retains moisture after being treated with aqueous sodium bromide, and even retains water after being treated with sodium bromide salt since sodium bromide is hygroscopic.

Saltation is another mechanism that leads to a build-up of particles in conveying systems. Saltation occurs when particles settle along the bottom of a pipe. As the particle size drops below about 15 μm, Cunningham slip becomes relevant and the “no slip” condition at the particle surface begins to break down. As slip at the surface becomes relevant, smaller particles become more difficult to keep suspended in the gas stream, and saltation occurs. Particle accumulation on surfaces of conveying lines is also more problematic as the length of the conveying line increases. Material accumulation is particularly problematic for long runs, such as conveying lines of 800 feet or more.

As powdered sorbent material accumulates, the pressure drop across the conveying system increases until one of three situations occurs. First, the material may continue to accumulate until the shear force imparted by the gas stream overcomes the cohesive strength of the accumulated material and a large quantity of the material suddenly discharges from the surface. Such an event can result in a pressure spike that can trip the system and cause system shut down. System shut down is an unacceptable event. In a second scenario, the powdered material may continue to accumulate until the pressure drop through the conveying line causes the pressure at the motive force inlet to drop below the design limits of the conveying system, which operates under vacuum. Again, this second condition eventually can cause the system to trip and shut down. Third, it is possible that powdered material accumulates to a limited extent where the accumulated material does not cause either of the two above-stated failures. In this third case, the system pressure drop increases to a smaller extent that is overcome by the system motive force, such as a blower. In this third situation, small sluffing events occur on a continuous or ongoing basis, but the magnitude of each sluffing event is sufficiently small as to not trip the system or cause a system shut down. Nonetheless, the increase in system pressure drop increases operating costs due to the increased energy requirements.

In one set of embodiments, to reduce or eliminate the problem of powdered materials accumulating on conveying line surfaces, particles of an erodant material are injected into the gas stream of the conveying system. The erodant material can comprise particles that weigh significantly more than a sorbent particle of median particle size d₅₀ as is discussed in more detail below. The erodant material may be comprised of substances that do not interfere with mercury adsorption and in some cases may contribute to sorbent activity. For example, the erodant material may be a sorbent material that captures contaminants by physisorption, chemisorption, or both. The erodant material may also be disposed of or reclaimed using methods that require little or no change to the methods currently used for disposing of or reclaiming sorbents. In some embodiments, the erodant material is captured separate from the sorbent material due to its greater size and/or mass. In other embodiments, the erodant material is captured together with the sorbent material after use and is treated in the same or similar way.

As used herein, “erodent material” refers to a material that tends to cause erosion when conveyed through a conduit. Also, while generally referred to herein as an “erodent material” for consistency and ease of understanding the present disclosure, the disclosed methods and compositions are not limited to that specific terminology. Erodant material alternatively can be referred to, for example, as an erodant, an erodent, an erodent material, or other terms.

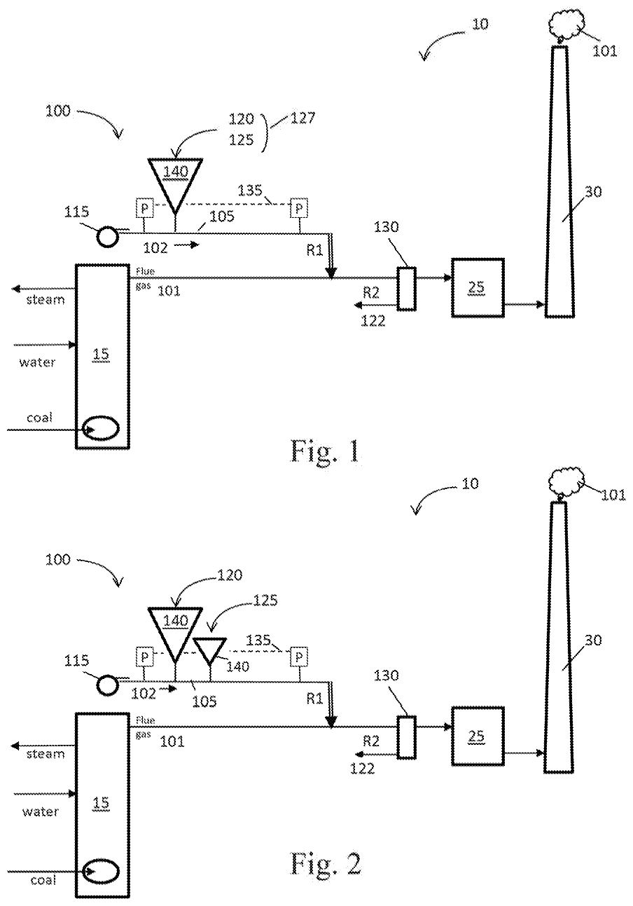

Referring to FIG. 1, a schematic diagram illustrates one embodiment of a pneumatic conveying system 100 in accordance with an embodiment of the present disclosure. In FIGS. 1-2, conveying system 100 is illustrated as part of a power plant 10; however conveying system 100 may stand alone or be part of another process. For example, conveying system 100 is configured to transport fine particle or powdered materials at a material handling facility.

In one embodiment, conveying system 100 includes a conveying line or conduit 105, a prime mover 115 configured to move a gas stream 102 (e.g., air) through conduit 105 at a gas velocity sufficient to entrain small-particle sorbent material 120 (or other powdered material) to be injected into flue gas stream 101. Conveying system 100 optionally includes a particle collector 130 to recover particles of spent sorbent 122. Particle collector 130 can be, for example, a cyclone separator, a fabric filter, an electrostatic precipitator, or other equipment known in the art suitable for separating fine particles from flue gas stream 101. In one embodiment, conduit 105 is a pipe with an inside diameter of 2, 3, or 4 inches. Other sizes and shapes of conduit 105 are acceptable.

In the example power plant 10 shown in FIG. 1, a gas stream 102 (e.g., air or other conveying medium) travels through conduit 105 of conveying system 100 with the aid of prime mover 115, such as a blower or inductor. To remove mercury contaminants from gas stream 102, particles of sorbent material 120 are injected into flue gas stream 101 downstream of boiler 15. Flue gas stream 101 then passes through an optional particle collector 130 to recover spent sorbent 122 from flue gas stream 101 before flue gas stream 101 enters a scrubber 25 and eventually discharged to the environment through a stack 30.

Gas stream 102 of conveying medium has a gas velocity sufficient to entrain particles of sorbent material 120. For example, gas stream 102 can have a gas velocity of about 30-80 feet per second through conduit 105 configured as a pipe with an inner diameter of 2, 3, or 4 inches. In one embodiment, conveying system 100 has a gas velocity of 40 feet per second and a sorbent material 120 loading of 2.2 pounds per minute. In another embodiment, conveying system 100 has a gas velocity of 60 feet per second and a sorbent material 120 loading of 4.4 pounds per minute. Other suitable gas velocities, conduit sizes, and solids loadings are acceptable and considered to be within the scope of the present disclosure.

Erodant particles 125 may be injected into gas stream 102 (e.g., a gas stream of air or other gas) continuously or at spaced intervals as necessary to reduce or prevent accumulation of sorbent material 120 in conveying system 100. In some embodiments as illustrated in FIG. 1, for example, a mixture 127 of erodant particles 125 and sorbent particles 120 is injected into gas stream 102 on a continuous basis. In other embodiments, such as shown in FIG. 2, for example, erodant particles 125 are continuously injected into gas stream 102 separately from sorbent particles 120, so that the solids loading for erodant material 125 can be controlled independently of the solids loading for sorbent material 120.

In some embodiments, for example, particles of erodant material 125 are injected periodically. For example, particles of erodant material 125 are injected intermittently into gas stream 102 with a regular or irregular frequency. For example, pulses of erodant material 125 are injected into conduit 105 as needed to reduce or eliminate accumulated sorbent material 120. In one embodiment, each pulse of erodant material 125 is from 0.5% to 2.0% or from 0.5% to 3.0% by weight of sorbent material 120 injected into gas stream 102 since the previous pulse of erodant material 125. In other embodiments, particles of erodant material 125 are added to sorbent material 120 and then injected into gas stream 102 as a mixture. For example, erodant material 125 is as added to hopper 140 containing sorbent material 120. In other embodiments, erodant material 125 is mixed with sorbent material 120 and injected into conveyance system 100 as a heterogeneous mixture 127. In one embodiment, erodant material 125 and sorbent material 120 are combined in a heterogeneous mixture 127 with erodant material 125 making up 0.5% to 2.0% or 0.5% to 3.0% by weight of mixture 127. In one embodiment, erodant material 125 is 1.0% or 1.5% by weight of mixture 127.

In some embodiments, a line pressure P or system pressure drop 135 of conveying system 100 is used at least in part to determine when particles of sorbent material 120 have accumulated on the surfaces of conduit 105 and/or other surfaces of conveying system 100. In some embodiments, one or more individual measurement of line pressure P along conduit 105 is monitored to detect accumulation of sorbent material 120. For example, one or more electronic pressure monitor or a monitoring worker detects an unacceptable rate of change in system pressure drop 135 (or line pressure P) or an unacceptable level of system pressure drop 135 (or line pressure P) and initiates a release of erodant particles 125 into conduit 105 based on the system pressure drop 135. For example, after detecting an increase in system pressure drop 135 for conveying system 100 to or beyond a threshold value, the pressure monitor(s) communicates the condition to the operator or to system controls. Conveying system 100 then injects particles of erodant material 125 into gas stream 102, such as by opening a feed valve. Alternately, for example, a worker observes system pressure drop 135 or a rate of change in system pressure drop 135 or line pressure P reaching or exceeding a threshold value and manually adds erodant material 125 to feed hopper 140 for injection into gas stream 102 or directly to conduit 105. In another example, the pressure monitor(s) detects a rapid increase in system pressure drop 135 or line pressure P, and communicates a signal to system controls to inject erodant material 125. In yet another example, where erodant material 125 is injected into gas stream 102 separately from sorbent material 120, the pressure monitor(s) detects an increase in system pressure drop 135 or line pressure P and increases the solids loading of erodant material 125.

In other embodiments, a feed rate R1 and/or a receiving rate R2 of sorbent material 120 is used as the basis or part of the basis for determining whether erodant material 120 is accumulating in conveying system 100. For example, a spike in the receiving rate R2 indicates sluffing events in conveying system 100, especially when accompanied by an increase in system pressure drop 135 or line pressure P. In another example, a change in receiving rate R2 inconsistent with a change in feed rate R1 is indicative of material accumulation or sluffing events. Accordingly, a solids loading of erodant material 125 may be increased or decreased to maintain a substantially steady system pressure drop 135 or line pressure P and substantially steady value of feed rate R1 relative to receiving rate R2 of solids.

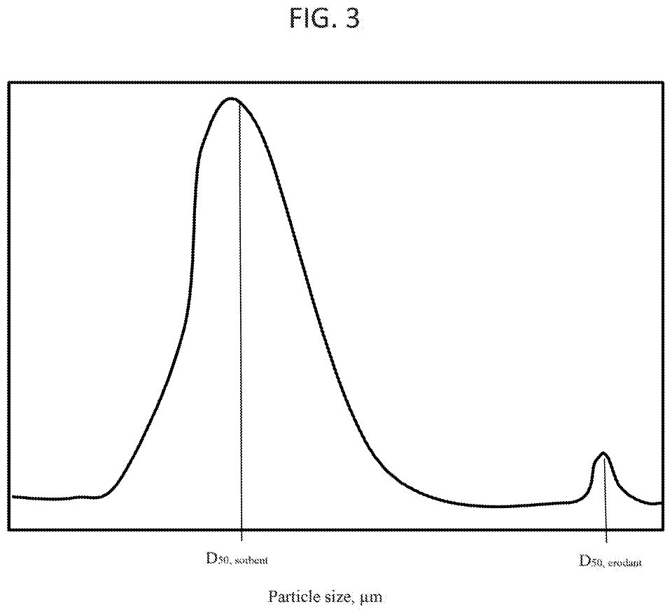

FIG. 3 illustrates a plot of an example particle size distribution for mixture 127 contains particles of sorbent material having a median sorbent particle size d₅₀, sorbent from 1 μm to 28 μm and particles of erodant material 125 having a median erodant particle size d_{50, erodant} of at least 150 μm, wherein the erodant material is provided in an amount from 0.5% to 3% by weight of the particles of sorbent material 120. Sorbent material 120 exhibits a median sorbent particle size d_{50, sorbent} that is separate and distinct from a median erodant particle size d_{50, erodant}, since the median erodant particle size d_{50, erodant} relates to particles of erodant material 125 that are significantly greater in size than particles of sorbent material 120.

In one embodiment, the sorbent material 120 is activated carbon configured for adsorption of mercury contaminants, where the activated carbon has a median particle size d₅₀ ranging from 1 μm to 18 μm, e.g., from 1 μm to 15 μm, from 1 μm to 13 μm, from 1 μm to 10 μm, from 3 μm to 18 μm, from 3 μm to 15 μm, from 3 μm to 13 μm, from 3 μm to 10 μm, from 4 μm to 18 μm, from 4 μm to 15 μm, from 4 μm to 13 μm, from 4 μm to 10 μm, from 5 μm to 18 μm, from 5 μm to 15 μm, from 5 μm to 13 μm, from 5 μm to 10 μm, from 8 μm to 18 μm, from 8 μm to 15 μm, from 8 μm to 13 μm, from 9 μm to 18 μm, from 9 am to 15 μm, or from 9 μm to 13 am. The activated carbon may be halogenated or non-halogenated.

In other embodiments, sorbent material 120 is activated carbon with a median particle size d₅₀ ranging from 1 μm to 28 μm, e.g., e.g., from 1 μm to 25 μm, from 1 μm to 23 μm, from 1 μm to 21 μm, from 1 μm to 15 μm, from 1 μm to 13 μm, from 1 μm to 10 μm, from 3 μm to 18 μm, from 3 μm to 15 μm, from 3 μm to 25 μm, from 3 μm to 23 μm, from 3 μm to 21 μm, from 3 μm to 13 μm, from 3 μm to 10 μm, from 4 μm to 18 μm, from 4 μm to 15 μm, from 4 μm to 13 μm, from 4 μm to 10 μm, from 5 μm to 25 μm, from 5 μm to 23 μm, from 5 μm to 21 am, from 5 μm to 18 μm, from 5 μm to 15 μm, from 5 μm to 13 μm, from 5 μm to 10 μm, from 8 μm to 25 μm, from 8 μm to 23 μm, from 8 μm to 21 μm, from 8 μm to 18 μm, from 8 μm to 15 μm, from 8 μm to 13 μm, from 8 μm to 10 μm, from 9 μm to 25 μm, from 9 μm to 23 μm, from 9 μm to 21 μm, from 9 μm to 18 μm, from 9 μm to 15 μm, or from 9 μm to 13 am. The activated carbon may be halogenated or non-halogenated.

In some embodiments, where sorbent material 120 is activated carbon with a median particle size d₅₀ ranging from 1 μm to 28 μm, or from 1 μm to 18 μm as noted above, the sorbent material has a ratio of d₉₅ to d₅₀ ranging from 1.5 to 3, including from 2 to 3 or from 2.5 to 3.

Additional embodiments of activated carbon sorbent material 120 may include or exclude the d₅₀ values provided above and can exhibit a d₉₅ particle size distribution ranging from 1 μm to 28 μm, provided that the d₉₅ particle size is greater than the mean particle size d₅₀. e.g., from 1 μm to 27 μm, from 1 μm to 26 μm, from 1 μm to 25 μm, from 1 μm to 23 μm, from 1 μm to 20 μm, from 1 μm to 18 μm, from 1 μm to 15 μm, from 1 μm to 10 μm, from 3 μm to 28 μm, from 3 μm to 27 μm, from 3 μm to 26 μm, from 3 μm to 25 μm, from 3 μm to 23 μm, from 3 μm to 20 μm, from 3 μm to 18 μm, from 3 μm to 15 μm, 3 μm to 10 μm, from 5 μm to 28 μm, from 5 μm to 27 μm, from 5 μm to 26 μm, from 5 μm to 25 μm, from 5 μm to 23 μm, from 5 μm to 20 μm, from 5 μm to 18 μm, from 5 μm to 15 μm, or from 5 μm to 10 μm. In some embodiments of the sorbent material where the d₉₅ particle size distribution ranges from 1 μm to 28 μm, the activated carbon has a d₅₀ particle size ranging from 8 μm to 18 μm, e.g., from 8 μm to 15 μm, from 8 μm to 13 μm, from 8 μm to 10 μm, from 9 μm to 18 μm, from 9 am to m, or from 9 μm to 13 am.

An example of erodant material 125 in accordance with an embodiment of the present disclosure is granular activated carbon (GAC). In some embodiments, the granular activated carbon is halogenated, such as with Bromine. In one embodiment, the granular activated carbon has a particle size of 8×20 mesh or other particle size distributions within that range, including 8×18 mesh, 8×16 mesh, 8×14 mesh, 8×12 mesh, 8×10 mesh, 10×20 mesh, 10×18 mesh, 10×16 mesh, 10×14 mesh, 10×12 mesh, 12×20 mesh, 12×18 mesh, 12×16 mesh, 12×14 mesh, 14×20 mesh, 14×18 mesh, 14×16 mesh, 16×20 mesh, 16×18 mesh, or 18×20 mesh.

In another embodiment, erodant material 125 is granular activated carbon with a particle size distribution of 20×50 mesh or other particle size distributions in that range, including 20×45 mesh, 20×40 mesh, 20×35 mesh, 20×30 mesh, 20×28 mesh, 20×25 mesh, 25×50 mesh, 25×45 mesh, 25×40 mesh, 25×35 mesh, 25×30 mesh, 25×28 mesh, 28×50 mesh, 28×45 mesh, 28×40 mesh, 28×35 mesh, 28×30 mesh, 30×50 mesh, 30×45 mesh, 30×40 mesh, 30×35 mesh, 35×50 mesh, 35×45 mesh, 35×40 mesh, 40×50 mesh, 40×45 mesh, and 45×50 mesh.

In some embodiments, erodant material 125 is granular activated carbon with a particle size of 50 mesh or greater, including +45 mesh, +40 mesh, +35 mesh, +30 mesh, +28 mesh, +25 mesh, +20 mesh, +18 mesh, +16 mesh, +14 mesh, +12 mesh, and +10 mesh.

In other embodiments, erodant material 125 is sand (i.e., crystallized silica or quartz sand) with a particle size greater than 100 mesh, including +100 mesh, +80 mesh, +70 mesh, +60 mesh, +50 mesh, +45 mesh, +40 mesh, +35 mesh, +30 mesh, +28 mesh, +25 mesh, +20 mesh, +18 mesh, +16 mesh, +14 mesh, +12 mesh, and +10 mesh. In other embodiments, the particle size of the sand is between 100 mesh and 60 mesh.

Other erodant materials 125 and sizes are acceptable as is discussed in more detail below. The maximum particle size for the erodant material is dictated in part by the gas velocity of the conveyance system 100. That is, the gas velocity must be sufficient to effectively convey particles of erodant material 125 through conveyance system 100. Also, as the particle mass increases, the particle size of erodant material 125 may be limited by an undesirable amount of wear on the conduit and other components of conveyance system 100.

Table 1 below relates the US Sieve Series mesh number with the mesh opening size in microns.

TABLE 1

| US Mesh # | Mesh opening, μm |
|---|---|
| 6 | 3360 |
| 7 | 2830 |
| 8 | 2380 |
| 10 | 2000 |
| 12 | 1680 |
| 14 | 1410 |
| 16 | 1190 |
| 18 | 1000 |
| 20 | 841 |
| 25 | 707 |
| 28 | 700 |
| 30 | 595 |
| 35 | 500 |
| 40 | 420 |
| 45 | 354 |
| 50 | 297 |
| 60 | 250 |
| 70 | 210 |
| 80 | 177 |
| 100 | 149 |
| 120 | 125 |

Using the particle size and material density of erodant material 125, the mass of particles of sorbent material 120 may be related to the mass of particles of erodant material 125. In one example, sorbent material 120 or erodant material 125 may be activated carbon, which has a skeletal density of about 2.0 g/cm³ and an apparent density of about 0.48 g/cm³. The true particle density will be between the skeletal density and the apparent density. For example, the true particle density of one embodiment of lignite-activated carbon is about 0.67 g/cm³ and accounts for the total pore volume of the particle. For this activated carbon, the total pore volume is about 1 cm³/gram. In another example, the erodant material may be play sand (also known as crystalline silica or quartz sand), which has a density of about 1.2 g/cm³.

Using the skeletal density of activated carbon and assuming the skeletal densities of powdered activated carbon (PAC) and granular activated carbon (GAC) to be about equal, the mass of a particle of PAC of median particle size d₅₀ of 3 μm is about 2.8 E-11 gram. In comparison, a particle of GAC with a particle size of about 300 μm (+50 mesh) has a mass of about 2.8 E-5 gram or about 1,000,000 times the mass of the 3 μm PAC particle. Similar calculations reveal that a quartz sand particle with a size of about 150 μm (+100 mesh) has a mass of 2.1 E-6 gram, or about 75,000 times the mass of the 3 μm PAC particle.

Also, using the skeletal density of activated carbon, the mass of a particle of PAC of 10 μm is about 1.0 E-9 gram. In comparison, a particle of GAC with a particle size of about 300 μm (+50 mesh) has a mass of about 2.8 E-5 gram or about 26,000 times the mass of the 10 μm PAC particle. Similar calculations reveal that a particle of quartz sand having a particle size of about 150 μm (+100 mesh) has a mass of about 2.1 E-6 gram, or about 2000 times the mass of the 10 μm PAC particle.

Further, using the skeletal density of activated carbon and density of quartz sand noted above, a particle of PAC with a particle size of 28 μm has a mass of about 2.3 E-8 gram. This particle of PAC represents the largest permissible median particle size d₅₀ of the sorbent material in some embodiments of the present disclosure. In comparison, a particle of granular activated carbon (GAC) with a particle size of about 300 μm (+50 mesh; the smallest permissible erodant particle of GAC in some embodiments) has a mass of about 2.8 E-5 gram or about 1200 times the mass of the 28 μm PAC particle. Further calculations reveal that quartz sand having a particle size of about 150 μm (+100 mesh), the smallest permissible sand erodant particle in some embodiments of the present disclosure, has a mass of 2.1 E-6 gram, or about 92 times the mass of the 28 μm PAC particle.

Due to the voids in the material, activated carbon has an apparent density of about 0.48 g/cm³. The mass of activated carbon particles is similarly calculated using the apparent density of 0.48 g/cm³. Assuming the apparent density of PAC and GAC to be about equal, a particle of PAC with a particle size of 3 μm has a mass of about 6.8 E-12 gram. In comparison, a particle of granular activated carbon (GAC) with a particle size of about 300 μm (+50 mesh) has a mass of about 6.6 E-6 gram or about 1,000,000 times the mass of the 3 μm PAC particle. Similar calculations reveal that quartz sand having a particle size of about 150 μm (+100 mesh) has a mass of 2.1 E-6 gram, or 300,000 times the mass of the 3 μm PAC particle.

Also, a particle of PAC of 10 μm size has a mass of about 2.5 E-10 gram. In comparison, a particle of GAC with a particle size of about 300 μm (+50 mesh) has a mass of about 6.6 E-6 gram or about 100,000 times the mass of the 10 μm PAC particle. Similar calculations reveal that quartz sand having a particle size of about 150 μm (+100 mesh) has a mass of about 2.1 E-6 gram, or about 8500 times the mass of the 10 μm PAC particle.

Further, using the apparent density of PAC and density of quartz sand noted above, a particle of PAC with a particle size of 28 μm has a mass of about 5.5 E-9 gram. This particle of PAC represents the largest permissible d₅₀ particle size of sorbent material 120 in some embodiments of the present disclosure. In comparison, a particle of granular activated carbon (GAC) with a particle size of about 300 μm (+50 mesh; the smallest permissible erodant particle of GAC in some embodiments) has a mass of about 6.6 E-6 gram or about 1200 times the mass of the 28 μm PAC particle. Further calculations reveal that quartz sand having a particle size of about 150 μm (+100 mesh), the smallest permissible sand erodant particle in some embodiments of the present disclosure, has a mass of 2.1 E-6 gram, or about 380 times the mass of the 28 μm PAC particle.

Thus, in general, the mass of particles of erodant material 125 is at least fifty times greater than the mass of sorbent material 120 particles of median particle size d₅₀. In other embodiments, the mass of a particle of erodant material 125 is at least 100 times, at least 200 times, at least 300 times, at least 1000 times, at least 2000 times, at least 5000 times, at least 10,000 times, at least 20,000 times, at least 50,000 times, at least 100,000 times, at least 200,000 times, at least 500,000 times, or at least 1,000,000 times the mass of a particle of sorbent material 120 of median particle size d₅₀.

In accordance with other embodiments of the present disclosure, the mass ratios of erodant material 125 particles and sorbent material 120 particles discussed above may be applied to select other erodant materials, including silica, sea shell, walnut shell, pecan shell, corn hull, olive pit, peach pit, rubber (e.g., tire), rice hull, coconut hull, corncob, coal, wood chips, metal filings, beach sand, aluminum oxide, glass beads, plastic beads or particles, coal slag, mineral slag, petroleum coke, steel grit, steel shot, staurolite mineral, pumice, garnet, granite, silicon carbide, silicon, sodium bicarbonate, other raw and processed materials known in the art, and mixtures of these and other materials. In some embodiments, the erodant material 125 has a hardness that is at least as hard or harder than sorbent material 120, but this is not required.

In some embodiments, the particles of erodant material 125 have a spherical or spheroidal shape. In other embodiments, particles of erodant material 125 have an angular shape, such as cubic, irregular, or other shape. In some embodiments, the density of erodant material 125 is at least as great as the density of sorbent material 120.

Experimental Data

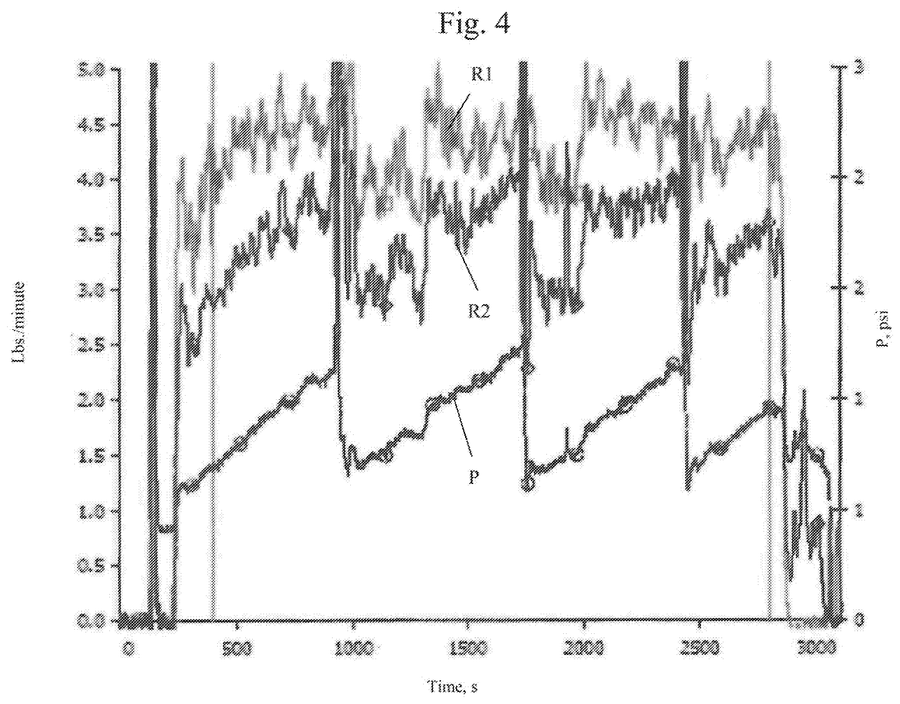

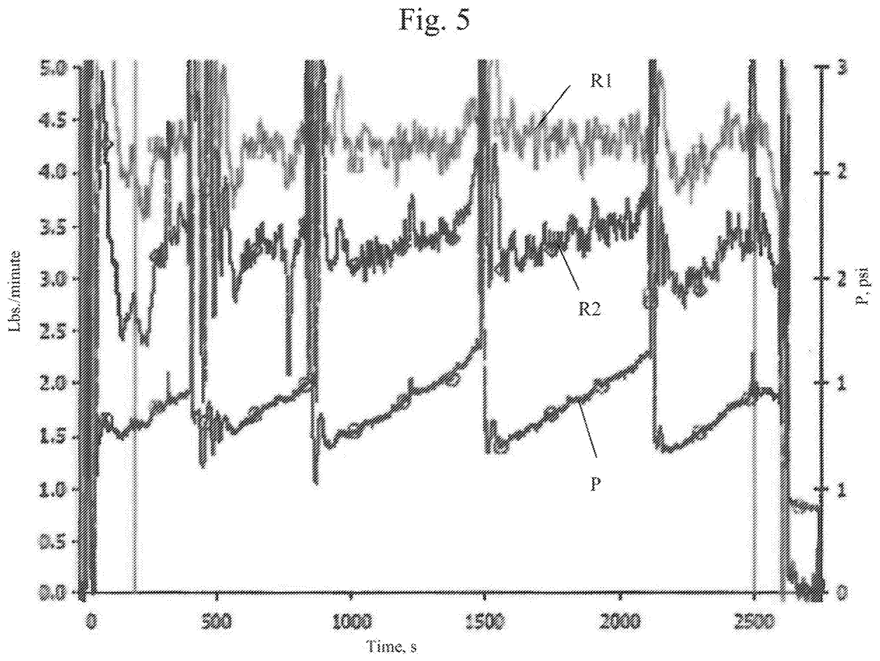

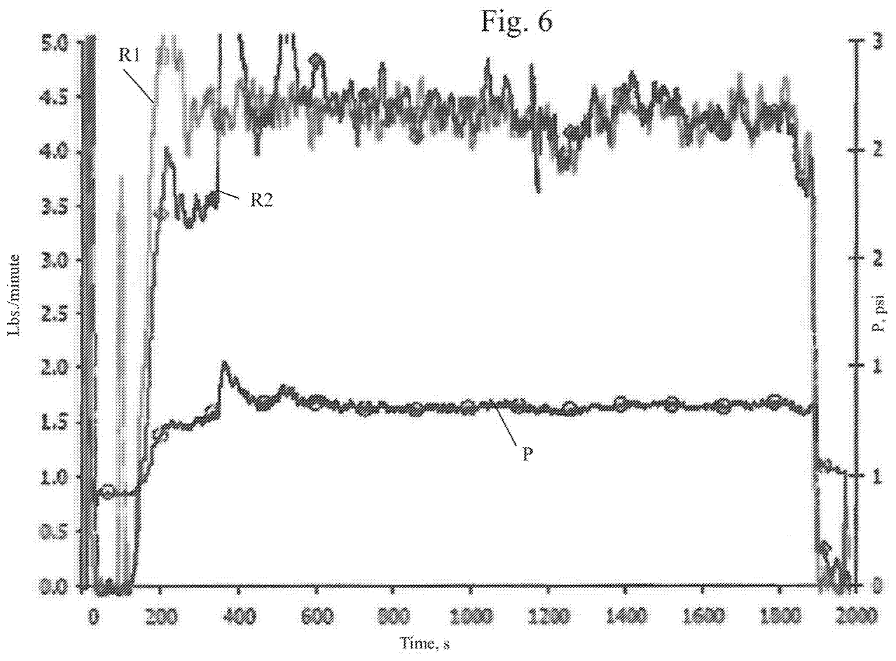

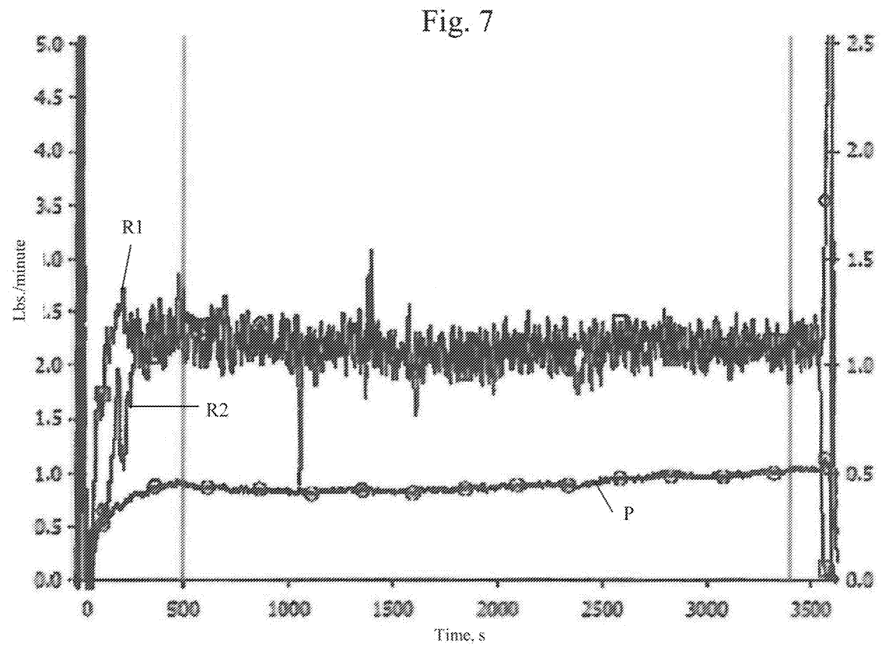

FIGS. 4-7 each show experimental data with a plot of system pressure P, material feed rate R1, and material receiving rate R2 vs. time for one embodiment of pneumatic conveying system 100. For each of FIGS. 4-7, sorbent material 120 is a brominated powdered activated carbon sold as DARCO® Hg-LH Extra SP by Cabot Corporation of Boston, Mass. For FIGS. 6-7, erodant material 125 is 8×20 mesh bituminous-based granular activated carbon. The data of FIGS. 4 and 6 was obtained with a gas velocity of 60 ft./second and a sorbent material 120 solids loading of 4.4 lbs./minute. The data of FIGS. 5 and 7 was obtained with a gas velocity of 40 ft./second and a sorbent material 120 solids loading of 2.2 lbs./minute. FIGS. 3 and 4 show system pressure P, material feed rate R1, and material receiving rate R2 when sorbent material 120 is fed without erodant material 125. FIGS. 5 and 6 show system pressure P, material feed rate R1, and material receiving rate R2 when sorbent material 120 is blended with erodant material 125 and injected as a mixture 127, where erodant material 125 is 1.5% by weight of mixture 127.

As shown in FIGS. 4 and 5, the system pressure P periodically increases as sorbent material 120 accumulates on the surfaces of conveying system 100. After gradually increasing for roughly 800 seconds, the system pressure P spikes. The spikes in system pressure P correspond to sluffing events in which a significant amount of accumulated sorbent material 120 detaches from the surface of the conveying system 100. The feed rate R1 and receiving rate R2 of sorbent material 120 follows the general trend of system pressure P. Also, feed rate R1 is greater than receiving rate R2 of sorbent material 120, indicating that sorbent material 120 is accumulating in conveying system 100.

FIGS. 6 and 7 plot system pressure P vs. time with a mixture 127 of sorbent material 120 and erodant material 125. Here, erodant material 125 is 1.5% by weight of mixture 127 and consists of granular activated carbon with a particle size of 8×20 mesh (i.e., particles between 841 μm and 2380 μm). Data in the plot of system pressure P vs. time indicates little to no accumulation of sorbent material during operation as indicated by relatively stable system pressure P. Also, the plots of FIGS. 6-7 exhibit a substantially stable feed rate R1 and receiving rate R2 of mixture 127. Also, feed rate R1 is substantially equal to receiving rate R2. When R1=R2, no accumulation of mixture 127 occurs. The larger particles of granular activated carbon effectively scour the surfaces of conveying system 100 to prevent accumulation of sorbent material 120.

As shown in the experimental data of FIGS. 4-7 in light of the foregoing discussion, injecting erodant material 125 to gas stream 102 (e.g., air) along with sorbent material 120 has shown to improve the conveyance of the sorbent material 120 in pneumatic conveyance systems 100. Specifically, it is believed that the particles of erodant material 125 scour the surfaces of conveyance system 100, such as along conduit walls and equipment surfaces, to reduce or eliminate accumulation of sorbent material 120. Thus, for sorbent materials 120 such as powdered activated carbon and other powdered materials having fine particle sizes, erodant material 125 is particularly advantageous. Advantages of using erodant material 125 are apparent in pneumatic conveyance generally, and in processes that use pneumatic conveyance, such as removal of mercury and other contaminants from flue gas streams.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

1-29. (canceled)

30. A method of removing mercury from a flue gas stream resulting from coal combustion, the method comprising:
injecting particles of sorbent material into the flue gas stream resulting from coal combustion, the particles of sorbent material having a median sorbent particle size d₅₀, sorbent from 1 μm to 28 μm; and
injecting particles of erodant material into the flue gas stream in an amount from 0.5% to 3% by weight of the particles of sorbent material, the particles of erodant material having a median erodant particle size d_{50, erodant} of at least 150 μm.

31. The method of claim 30, wherein the step of injecting the particles of sorbent material includes selecting the particles of sorbent material comprising powdered activated carbon.

32. The method of claim 30, wherein the step of injecting the particles of sorbent material includes selecting the particles of sorbent material having the median sorbent particle size d₅₀, sorbent ranging from 8 μm to 18 μm.

33. (canceled)

34. The method of claim 32, wherein the step of injecting the particles of erodant material includes selecting the particles of erodant material comprising granular activated carbon with an erodant particle size greater than 50 mesh.

35. (canceled)

36. The method of claim 32, wherein the step of injecting the particles of erodant material includes selecting the particles of erodant material comprising granular activated carbon having a particle size distribution of 20×80 mesh.

37. The method of claim 30, wherein the step of injecting the particles of erodant material includes selecting the particles of erodant material comprising crystalline silica with an erodant particle size greater than 100 mesh.

38. (canceled)

39. (canceled)

40. The method of claim 30, wherein the step of injecting the particles of erodant material includes selecting the particles of erodant material comprising one or more materials selected from the group consisting of granular activated carbon, silica, quartz sand, sea shell, walnut shell, pecan shell, corn hull, olive pit, peach pit, rubber, rice hull, coconut hull, corncob, coal, wood chips, metal filings, beach sand, aluminum oxide, glass beads, plastic beads, plastic particles, coal slag, mineral slag, petroleum coke, steel grit, steel shot, staurolite mineral, pumice, garnet, granite, silicon carbide, silicon, and sodium bicarbonate.

41. A mixture comprising:
powdered activated carbon having a median sorbent particle size d_{50, sorbent} from 1 μm to 28 μm;
granules of erodant material having a median erodant particle size d_{50, erodant} of at least 150 μm, the granules of erodant material in an amount from 0.5% to 3% by weight of the particles of the powdered activated carbon; and
wherein the powdered activated carbon is heterogeneously mixed with the erodant particles.

42. The mixture of claim 41, wherein the granules of erodant material comprise one or more materials selected from the group consisting of granular activated carbon, silica, quartz sand, sea shell, walnut shell, pecan shell, corn hull, olive pit, peach pit, rubber, rice hull, coconut hull, corncob, coal, wood chips, metal filings, beach sand, aluminum oxide, glass beads, plastic beads, plastic particles, coal slag, mineral slag, petroleum coke, steel grit, steel shot, staurolite mineral, pumice, garnet, granite, silicon carbide, silicon, and sodium bicarbonate.

43. The mixture of claim 41, wherein a mass of one of the granules of erodant material is at least 100 times a sorbent particle mass of one particle of powdered activated carbon with a particle size equal to the median sorbent particle size d₅₀, sorbent.

43. (canceled)

44-46. (canceled)

47. The mixture of claim 41, wherein the granules of erodant material have an erodant particle size distribution of 8×20 mesh.

48. (canceled)

50. The mixture of claim 41, wherein the granules of erodant material comprise granular activated carbon having an erodant particle size greater than 50 mesh.

51. The mixture of claim 41, wherein the granules of erodant material comprise quartz sand having an erodant particle size greater than 100 mesh.

52. The mixture of claim 51, wherein the erodant particle size is not greater than 60 mesh.

53. The mixture of claim 41, wherein at least some of the granules of erodant material have a spheroidal shape.

54. The mixture of claim 41, wherein the median sorbent particle size from 8 μm to 18 μm.

55. (canceled)

56. (canceled)
